(19) United States
(12) Patent Application Publication
(10) Pub. No.: US 2021/0182802 A1
(43) Pub. Date: Jun. 17, 2021

(54) SYSTEM AND METHOD FOR CONTROLLED PROCESSING, MONITORING AND ACCOUNTING FOR THE DISPOSAL OF A DISPOSAL OBJECT

(71) Applicant: Francotyp-Postalia GmbH, Berlin (DE)

(72) Inventors: Uwe Hübler, Neuenhagen (DE); Clemens Heinrich, Oranienburg (DE); Dirk Rosenau, Berlin (DE); Stephan Günther, Glienicke (DE)

(73) Assignee: Francotyp-Postalia GmbH, Berlin (DE)

(21) Appl. No.: 17/123,752

(22) Filed: Dec. 16, 2020

(30) Foreign Application Priority Data
Dec. 17, 2019 (DE) 102019134627.4

(51) Int. Cl. G06Q 10/00; G06Q 30/04; G06Q 10/08; G06N 20/00

(52) U.S. Cl. CPC G06Q 10/30; G06Q 30/04; G06Q 2220/00; G06N 20/00; G06Q 10/0833

(57) ABSTRACT

A system and a method for controlled processing, monitoring and billing of the disposal of a disposal object (e.g. waste) may include a workstation, a control device, a security module, an acquisition device, an auditor device and a decentralized server. Using the acquisition device, disposal object information of a disposal object, operating information, and/or status information is acquired. Based on this information and a provided input information, the auditor device generates an auditing information. The control device controls the work station and, depending on the auditing information, initiates and/or controls a work process for processing the disposal object. The acquisition device may allow the acquisition of product information about the product obtained by the work process, so that an individual accounting can be created based on the available information about the disposal object and its processing.

### CROSS REFERENCE TO RELATED APPLICATIONS

This patent application claims priority to German Patent Application No. 102019134627.4, filed Dec. 17, 2019.

### BACKGROUND

### Field

The disclosure relates to a system and a method for controlled processing, monitoring and billing of the disposal of a disposal object, namely waste. The system may include at least one workstation, a control device, a security module, an acquisition device, an auditor device and a decentralized server. By means of the acquisition device, at least one of disposal object information of a disposal object and/or operating information and/or status information is acquired. Based on this information and a provided input information, the auditor device generates an auditing information. The control device controls the work station and, depending on the auditing information, initiates and/or controls a work process for processing the disposal object. Preferably, the acquisition device also allows acquisition of product information about the product obtained by the work process, so that individual billing can be generated based on the information about the disposal object and its processing.

### Related Art

Worldwide, the amount of waste generated amounts to approximately two billion tons of waste per year. Disposing of this considerable amount of waste poses a huge challenge to mankind and constantly demands new innovations. Waste is usually landfilled, incinerated or recycled. Especially for the transport and storage of waste, it is essential to compress or compact the waste in order to enable space-efficient storage.

Compression and compaction is accomplished by waste compactors. Waste compactors are known that compress different types of waste at different pressures. For example, recyclable plastic waste may only be compacted with very low pressure, as it is poured as loosely as possible onto belts in sorting facilities and can thus be better separated according to material type. Bulky waste or green waste, on the other hand, can be compacted with much greater pressure. A compression ram generally compacts the waste contained in a container to a certain predetermined final pressure. The compacting ram subsequently returns to its original position to allow for new waste to be placed inside. A container is generally full when the final pressure no longer allows compaction of the contained material. Full containers are picked up by the operator and taken for disposal. The specified final pressure varies depending on the type of waste.

However, known waste compactors are disadvantageous in that customers often do not dispose of their waste sorted by type. This results in significant additional costs for disposal, as the waste has to be sorted again. Despite the technical possibilities for waste identification, it is not possible to charge the customer subsequently because it is logistically very costly to allocate the waste for disposal and to provide the customer with the corresponding evidence.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a system for controlled processing, monitoring and billing of the disposal of a disposal object according to an exemplary embodiment.

FIG. 2 is a flowchart of a method for a controlled processing, monitoring and billing of the disposal of a disposal object according to an exemplary embodiment.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the disclosure is to provide a system and/or a method for the disposal of waste which eliminates the disadvantages of the prior of the art. In particular, a system and/or a method should be provided which, with little logistical effort, enables individual calculation of the disposal service as a function of the service ordered and the service actually used. In addition, the method and/or the system should be characterized by the possibility of an optimal control and adjustment of the work processes as well as a high degree of security.

System for controlled processing, monitoring and billing of the disposal of an object of disposal, namely waste, comprising at least the following components: a workstation, a control device, a security module, an acquisition device, an auditor device, and a decentralized server, characterized in that
a) the remote server is adapted to transmit an input value to the auditor device;
b) the acquisition device is adapted to acquire at least one disposal object information of a disposal object and/or an operating information and/or a status information;
c) the auditor device is adapted to generate auditing information based on the disposal object information and/or the operating information and/or the status information as well as the input value;
d) the control device is adapted to control the work station and to initiate and/or regulate a work process for processing the disposal object in dependence on the auditing information;
e) the acquisition device is adapted to acquire a product information about a product obtained by the working process and to transmit said product information to the auditor device;
f) the auditor device is adapted to supplement the auditing information with the product information and to generate billing information based thereon;
wherein one or more data transmission processes are cryptographically secured at least by the security module.

A significant advantage of such a system lies in the low logistical effort required for the controlled processing, monitoring and billing of the disposal of a disposal object, since all the steps performed follow one after the other and/or in parallel in an automated manner. Moreover, the proposed system is particularly secure against data theft and/or data loss due to the use of a security module which cryptographically secures at least one data transmission process, preferably several, particularly preferably all data transmission processes. The provision of the input value via a decentralized server also enables flexible execution, both in terms of location and time, of the process contained in the system, which can respond to changes. The input of the input value by a customer to the decentralized server can advantageously be executed before or after the execution of the procedure from any location. Furthermore, the acquisition devices advantageously enable detailed and extensive monitoring of the disposal object and/or the product, whereby the processing parameters in the working process can be optimally aligned.

The components of the system are adapted in particular for data processing, wherein the components of the system comprise means or are adapted (configured) to execute the described process steps.

The proposed system includes at least a workstation, a control device, a security module, an acquisition device, an auditor device, and a decentralized server (or remote or external server). The workstation, the control device, the security module, the acquisition device, the auditor device, and the decentralized server are referred to as system components for the purposes of the disclosure. The term “at least” preferably means in the sense of the disclosure that the system comprises, for example, at least one workstation, but it may be equally preferred that the system comprises two or three workstations. This applies analogously to the other system components. It may also be that the system comprises other components in addition to the aforementioned system components. It may be preferred, in the spirit of the disclosure, that the system components be located together in one location. However, it may also be preferred that individual system components or groups of system components are located or set up at different locations.

In terms of the disclosure, the workstation is preferably arranged to perform at least one process step of a work process. Preferably, the work process comprises one or more process steps, wherein the process steps may be performed by one or more work stations of the proposed system. Preferably, the working process comprises processing of the disposal object, wherein the processing preferably comprises a manufacturing process selected from the group comprising: forming, shaping, separating, joining, coating and/or changing material properties (e.g. hardening, annealing, etc.). The manufacturing processes mentioned are known to the person skilled in the art. According to the disclosure, the disposal object is particularly preferably formed, namely compressed, i.e. pressed together. Compression is an advantageously particularly simple and therefore economical method of forming.

In a preferred embodiment, the work station is a press station and preferably comprises a pressure ram of a waste compactor. This plunger is adapted to preferably move along a travel path. The force for moving the plunger along the travel path is preferably applied mechanically and more preferably hydraulically. The skilled person is familiar with such a pressure ram of a waste compactor. A pressure ram advantageously provides a force evenly distributed over the ram contact surface.

However, the work station can also be a sorting station, a transport unit, a marking station, a heating station and/or a shredding station. Other work stations that are used in connection with the disposal of waste are also conceivable and can be controlled, managed and monitored by means of the system.

In a preferred embodiment, the work station is designed to be transported by means of a vehicle. In this case, a waste compactor or container, comprising one or more work stations, can be integrated in the frame of the vehicle or attached to a vehicle in the form of a separate structure (e.g. superstructure), whereby the structure can also be detached from the vehicle and parked at a location. Thus, it is possible to pick up the waste disposal object or waste from a customer and/or to provide the customer with a waste compactor or container for his own waste compaction.

In another preferred embodiment, the work station is stationary at one location. A stationary waste disposal system may comprise different work stations for different types of waste or different work processes. The stationary design allows a larger dimensioning of the work stations, whereby, for example, an increased amount of waste can be compacted with one compacting process. After the work process has been carried out, a product is produced. The product is preferably the processed waste disposal object. Advantageously, the product has lower volume compared to its state as a disposal object. In a further preferred embodiment, a product may comprise a plurality of successive disposal objects.

The auditor device according to the disclosure may preferably to be regarded as a central processing unit. It preferably comprises means for processing, storing, transmitting and receiving data. The auditor device is preferably in data connection with all system components, whereby data can be transferred between the system components. In a preferred embodiment, the auditor device executes all system-relevant algorithms and calculations by receiving input data from the relevant system components and, after execution of the algorithms, generating output data that is transmitted to corresponding further system components. The advantage of such an arrangement being that only the auditor device needs to be equipped with components for data processing (processor) and data storage.

It is particularly preferred in the sense of the disclosure that the auditor device comprises a security module. The security module preferably comprises or is formed by a hardware security module (HSM). The HSM may preferably also be part of the workstation or other component of the proposed system.

It is preferred in the sense of the disclosure that the HSM is a hardware-based cryptographic module which preferably has FIPS 140-2 certification. The provision of the FIPS-certified auditor device solves in particular a technical problem with technical means, namely the provision of a particularly secure data transmission within the system. The HSM may be formed by or comprise a single chip module, an autonomous multichip module or an embedded multichip module. Preferably, the HSM is adapted to store data in a particularly secure manner. In particular, an HSM is capable of generating, storing, using, and/or maintaining critical security parameters, such as passwords, confidential data, or keys for encrypting data. For example, the keys may be symmetric or asymmetric. Advantageously, HSMs may be used as cryptographic coprocessors. In preferred embodiments, an HSM may include battery-powered circuitry and/or voltage monitoring. In particular, this enables the integration or provision of a real-time clock for proper timekeeping and time stamping, which can ensure, for example, that expired keys can no longer be used. In addition, an HSM may include a redundant memory that can be used, for example, to simultaneously use multiple technologies to generate additional data security.

In particular, the HSM can be used to implement a public key infrastructure at the highest level, as is known to those skilled in the art.

The fact that the system components are equipped with a security module means that all data transfer processes can be cryptographically secured. Particularly advantageously, this makes the system resistant to manipulation and unauthorized reading of the data.

In a preferred embodiment of the disclosure, the HSM comprises a chain of certificates that are preferably loaded onto the device before the HSM is put into operation. The HSM is further adapted to generate its own private and public device keys. Preferably, the private key does not leave the HSM at any time, while the public key can be delivered externally, for example to a decentralized server for signing. In return, the HSM can receive a personalized, signed device certificate that allows the HSM to significantly increase security in an Internet of Things (TOT) system. The HSM can then be recognized and authenticated by the decentralized server as a “genuine” security module, which is made possible in particular by assigning a unique identifier. In this way, authenticated TLS (Transport Layer Security) connections can be established in a particularly straightforward manner.

In the sense of the disclosure, the auditor device may preferably also be referred to as an auditor, the terms being used as synonyms. In the sense of the disclosure, the monitoring of the auditor can also be considered as “listening” to the interrogation by the system control, the function of the system control being performed in particular by a control device within the proposed system.

In a preferred embodiment, the acquisition device comprises at least one sensor or sensor system. A sensor can determine physical (e.g., heat quantity, temperature, humidity, pressure, sound field quantities, brightness, acceleration) or chemical (e.g., pH value, ionic strength, electrochemical potential) properties and/or the material composition of its environment qualitatively or quantitatively as a measured variable. These quantities are recorded by means of physical or chemical effects and converted into an electrical signal that can be processed further.

In a preferred embodiment, the acquisition device comprises a sensor selected from the group comprising: temperature sensor, displacement sensor, pressure sensor (force sensor), acceleration sensor, image sensor. The person skilled in the art is aware of the specific embodiments and components included in such sensors.

The sensors of the acquisition device are preferably adapted to acquire a status information and/or an operating information and/or a disposal object information and/or product information. The combination of all information results in a comprehensive overall information, from which detailed knowledge of the disposal object and/or the product is obtained.

In accordance with the disclosure, the acquisition device can also be divided into several acquisition devices, the respective acquisition devices comprising different sensors.

In a preferred embodiment, the acquisition device comprises a memory, a processor, and/or a security module. This allows the acquisition device to subject the acquired information to pre-processing. This may, for example, comprise an initial analysis or filtering of the acquired data, whereby the auditor device advantageously requires less power for data processing as well as memory.

In one embodiment of the disclosure, a decentralized server is associated with the system but is preferably located remotely from the other system components. A server is known to the person skilled in the art. In the sense of the disclosure, a decentralized server is also to be understood as an external server or a remote server. The server may be in connection with the Internet.

In a further preferred embodiment, all or some system components are connected to each other, i.e. there is preferably a data connection between the system components. Due to the security modules preferably present in the system components, all data transmission processes (via the respective data connections) are preferably cryptographically secured. It is understood that in the preferred system, not all data transmission processes must necessarily be carried out in a cryptographically secured manner. For example, it may be preferred that a security module is not assigned to each system component and/or that some security modules do not secure data transmissions that are not critical to security in order to save power consumption of the preferred system. In the preferred embodiment of the disclosure, at least one data transmission process is cryptographically secured. In preferred embodiments, all data transmission processes are cryptographically secured by at least the security module.

The sending and receiving of data is also preferably understood as the transmission of data. The transmission is preferably wireless by means of directional or non-directional electromagnetic waves, wherein the range of the frequency band used may vary from a few hertz (low frequency) to several hundred terahertz (visible light) depending on the application and the technology used. According to the disclosure, the following data transmission methods are preferably used: Bluetooth, WLAN, ZigBee, NFC, Wibree, GPRS, EDGE, UMTS, HSPA, LTE, 5G or WiMAX in the radio frequency range as well as IrDA and free-space optical communication (FSO) in the infrared or optical frequency range. The skilled person is familiar with the data transmission methods from the prior art.

In a further embodiment, a plurality or all of the system components comprise an antenna configured to transmit and/or receive data. Wireless data transmission between the system components enables an advantageous design of the entire system, since no electrical cables (signal conductors) need to be laid between the system components. In particular, system components can be positioned independently of the location of other system components. For example, the system components: a workstation, a control device, a security module, an acquisition device, and an auditor device can be integrated in a waste compactor in Germany, while the decentralized (remote or external) server is located at a site in the USA.

In a preferred further embodiment of the disclosure, the system components comprise analog and digital outputs for a transmission of data via signal conductors. In this context, the signal conductor can preferably comprise an electrical conductor and/or an optical waveguide. An optical waveguide is thereby preferably configured as a fiber optic cable. A signal conductor may also preferably be designed as a coaxial cable. The advantage of a signal conductor is fast data transmission. It is also more secure against wireless transmission in the context of data theft and intrusion.

According to the disclosure, an input value of the central server is transmitted to the auditor device. Preferably, this is done by wireless data transmission. Preferably via the technologies of the mobile Internet UMTS, HSPA, LTE and/or 5G, the transmission of the input value to the auditor device is ensured. This can be done by a direct data connection to the decentralized server. However, one or more additional servers can also be interposed between the decentralized server and the auditor device, so that the decentralized server sends the input value to one (or more) intermediate servers, which then provide the input value to the auditor device. Advantageously, multiple intermediary servers can increase the security of the system because the data traffic is more difficult to trace.

According to the disclosure, the input value is preferably available on the decentralized server before the start of the work process, so that the server also transmits the input value to the auditor device before the start of the work process. However, the input value can be made available to the decentralized server during the work process, so that the server also transmits the input value to the auditor device during the work process.

The system is adapted so that it may nevertheless include the input value in the control. In a further preferred embodiment, no input value is available to the decentralized server, so that no input value is transmitted to the auditor device either. The system is adapted to start and control a working process anyway without the information of the input value. Advantageously, the system is able to act independently of the input value and, surprisingly, the system still generates billing information with few errors.

A “input value” preferably means information that the system receives from an external source, such as an external server, and that relates to the disposal object and/or a work process to be performed on the disposal object.

An input value is preferably input information that serves the system as a reference value and/or as an output value or guideline value. The input value is preferably defined by a user/customer. It may be information such as the (expected) disposal object type and/or the (expected) disposal object quantity and/or the payment already made for a disposal, etc. etc.

In a preferred embodiment, the auditing information is based on the disposal object information and/or the operating information and/or the status information and/or the input value and/or the product information. Preferably, the auditor device is adapted to forward or send the auditing information to the control device of the proposed system. For this purpose, the auditor preferably comprises the corresponding communication means. In this context, the auditor represents the information provider and the control device represents the information receiver.

According to the disclosure, the control device is designed to enable directional influencing of the behavior of the workstation. In a preferred embodiment, the control device is capable of controlling as well as regulating the workstation. When controlling, the work station is influenced with the aid of a manipulated variable—without the control variable having a feedback effect on the manipulated variable. According to the disclosure, control is preferably a process in which the “ACTUAL value” of a variable is determined and adjusted to a “SET value” by readjustment. The “ACTUAL value” is preferably determined by the acquisition device. By means of the regulation of the work station by the control device, it is advantageously possible to react to changes in the disposal object to be processed within a short time and to adjust the work station accordingly by the control device.

In terms of the disclosure, the auditing information produces an auditing result. For example, the auditing result may be positive if the auditing information matches corresponding SET values, while a negative auditing result is obtained if the auditing information does not match the SET values, where, for example, a non-match is sufficient to obtain an overall negative auditing result. In the case of a positive auditing result, a start signal for the work process can preferably be generated in the control device and sent to the work stations at which the process steps are performed. In the case of a negative auditing result, the generation and sending of a corresponding start signal is omitted. The described procedure can be repeated at a later time in case of a negative auditing result. If a positive auditing result is then received, this can lead to the execution of the work process.

In another preferred embodiment, the auditor device is a component of the workstation with which the work process is performed on a disposal object. Furthermore, all other system components may also be part of the workstation. According to the disclosure, each system component may be a component of a further system component.

In the sense of the disclosure, the product information is preferably selected from the group comprising product image, product size, product temperature, product density, product surface and/or waste type, for example green waste, bulky waste, plastic waste, waste glass, residual waste, waste paper and/or electronic waste, without being limited to these. For the bringing forth of product information, the capture of the product via the acquisition device is necessary.

Advantageously, the recording of this information makes the billing of a real service possible and comparable with a standard value.

Preferably, the billing information is created depending on the auditing information. Since the auditing information is defined by the input value, the status information, the operating information, the disposal object information and the product information, the auditing information preferably reflects the actual effort made for the disposal of the disposal object provided and may assign this effort to a corresponding billing information. Preferably, a comparison with an input value, which can include billing information already provided by the customer/user in the past, can also be made by the auditor device. Furthermore, the auditing information may also describe, for example, whether a work station is ready for use or not.

In another preferred embodiment of the disclosure, the security module comprises a storage device, wherein the auditing information and/or the billing information can be stored in the storage device. This allows the stored information to be used for other purposes at a later time, or to be read out or associated with a particular user profile. It may be preferred in the spirit of the disclosure to store the billing information locally or to access the billing information remotely.

Storing the billing information locally within the system, for example at the location where the data is generated and/or collected, enables pre-filtering of the data, so that, for example, not all data or data records need to be transmitted from the collection device to the auditor device, but only a significantly smaller amount of data. As a result of the fact that less data has to be transmitted overall, transmission resources are saved and the relevant data can be transmitted more rapidly and with less effort.

It may also be preferred in the sense of the disclosure that the security module is adapted to store the auditing information and/or the billing information in the decentralized server. In this way, the provision of a storage location within the system can be dispensed with, thus saving space or providing a particularly space-saving system. If the data is stored in a decentralized server, the data of different systems or different system components may be compared with each other. This can be done, for example, to determine average values or deviations as part of a benchmarking process. It is also possible to identify system components that are operating “at set values” or, for example, with particularly high consumption. Advantageously, this data can then be used in predictive maintenance or remote maintenance to optimize the operation of a system or facility.

In a further preferred embodiment of the disclosure, the system is characterized in that the auditor device is adapted to assign identification information to the disposal object and/or the product on the basis of the auditing information. An identification information advantageously enables the generation of an individual accounting of disposal objects.

In the sense of the disclosure, identification information is preferably information about the classification of a disposal object and/or product. For the identification of disposal objects and/or products, the auditor device is preferably designed in such a way that it may assign the disposal object and/or the product to a class on the basis of classification algorithms by means of all recorded data (e.g. status information, operating information, disposal object information, product information) as well as the input value and thus identify it. The identification information is determined accordingly via classification algorithms from the auditing information.

The assignment of the identification information may preferably be achieved both before the disposal object is processed and during the execution of the processing as well as after the processing.

The individual classes are preferably determined based on certain matching features. In other words, a classification algorithm is preferably a function that maps a feature space to a set of classes. For example, a feature of a disposal object and/or product may relate to its color, density, size or temperature, etc. In a preferred embodiment, the classification into which the disposal object and/or product can be classified is the waste type: green waste, bulky waste, plastic waste, waste glass, residual waste, waste paper and/or electronic waste.

In the sense of the disclosure, classification algorithms are particularly preferably based on artificial intelligence methods, in particular on machine learning algorithms. However, they can also be simple algorithms which do not use artificial intelligence methods.

The person skilled in the art knows that machine learning algorithms are a subarea of artificial intelligence. Machine Learning uses mathematical and statistical models to “learn” from data sets. In general, machine learning algorithms have the advantage that information that is too complex for a human observer can be automatically extracted from a large data set. There are a variety of machine learning algorithms that can be broadly categorized into three different learning methods: supervised learning, unsupervised learning, and reinforcement learning.

In accordance with the disclosure, supervised learning methods are particularly preferred for analyzing or processing the auditing information. In the supervised learning method, a so-called training process is first carried out. Herein, training data is provided in the form of input data together with the corresponding target data. The purpose of training in the machine learning process, is preferably to adjust parameters of a function so that the function is subsequently able to determine the target value with high accuracy from the corresponding input value. After the training process, the adapted function is used to predict target data for previously unseen input data. The function is described by a mathematical and/or statistical model.

In a preferred embodiment, the function is designed by support vector machines, Bayesian networks and/or decision trees. Particularly preferably, the function is described by an artificial neural network. According to the disclosure, the artificial neural networks can have different architectures and can be designed, for example, as Deep Feed Forward (DFF) Network, Recurrent Neural Network (RNN), Deep Convolutional Network (DCN), Deconvolutional Network (DN), Convolutional Neural Network (CNN), Deep Residual Network (DRN), Boltzmann Machine, Time Delay Neural Networks (TDNNs).

In the sense of the disclosure, the input data is preferably defined by the auditing information. The auditing comprising the acquired status information, operating information, disposal object information, product information as well as the input value.

According to the disclosure, target data is preferably defined by the classification into a certain class. Likewise, probabilities of belonging to a particular class can also be output as target data. This preferably corresponds to identification information in the sense of the disclosure.

In another preferred embodiment, the Unsupervised Learning method is used to analyze or process the auditing information. In Unsupervised Learning, the algorithm attempts to detect patterns in the input data that deviate from a structureless noise. The function in the training process is guided only by the similarities in the input data and adjusts its parameters accordingly, so that no output data is used for the training process.

In a preferred embodiment, the Unsupervised Learning method is used to perform segmentation or clustering of the input data or, preferably, compression of the input data. The skilled person is familiar with the terms clustering, segmentation and compression in connection with machine learning methods.

In a preferred embodiment, the Unsupervised Learning Algorithm preferably comprises Principal Component Analysis (PCA) and/or the K-Means algorithm and/or at least one neural network.

As already described, in both methods mentioned above, so-called training processes are carried out in a first step to determine optimal parameters of an above-mentioned machine learning function. Based on the adapted function, various statements are made after the training for previously unknown input data.

In another preferred embodiment, the reinforcement learning method is used for analyzing or processing the auditing information. In the reinforcement learning method, on the other hand, the training process takes place continuously even after the parameters of a function have been adjusted. Via “trial and error”, effects of various statements are observed and evaluated using the adjusted function for previously unknown input data. In response to these statements, the algorithm receives feedback, preferably represented abstractly in the form of a reward or punishment. Whereupon the algorithm further optimizes the function based on its parameters.

Accordingly, the algorithm continuously adapts or modifies the function of the machine learning process.

In a preferred embodiment, the reinforcement learning method comprises the Q-learning method and/or aforementioned neural networks and/or further neural networks as well as further algorithms known to the person skilled in the art.

In a further preferred embodiment, the system is characterized in that the auditor device is adapted to initiate a signature process, the signature process being initiated depending on a trigger event and being arranged to provide the signing device with a message about the trigger event. The signing device is preferably a component of the system.

In a further preferred embodiment, the system is characterized in that the system comprises a signing device and the auditor device is adapted to initiate a signature process, wherein the signature process is initiated depending on a trigger event and is adapted to
provide the auditor device with a tamper-proof confirmation from the signing device of knowledge of the trigger event, and/or
provide the auditor device with a tamper-proof release of the signing device for continuation or abortion (discontinuation, termination) of controlled processing, monitoring, and billing of the disposal of waste.

Such an arrangement advantageously ensures that the auditor device of the system receives a tamper-proof reaction to a trigger event of a responsible body and/or person, whereby the reaction may possibly only be in the form of an acknowledgement of receipt of the message about the trigger event. Based on the reaction, the auditor device preferably initiates subsequent process steps or generates new auditing information. The signature process—also referred to herein as digital signature—is used to authenticate digital messages and confirms that messages have been received from a known source and have not been altered during transmission. Digital signatures can be used to authenticate the message source. This means that both the auditor device and the signing device can be assured that the messages/messages/prescribed values/instructions received were generated by the legitimate sender. The importance of high confidence in sender authenticity is obvious for example for sensitive data such as termination data or accident situations for the workstations.

Furthermore, an important aspect of the definition of digital signatures is irrevocability. Thanks to this property, an entity—preferably the signing entity but also the auditing entity—that has signed information cannot deny having signed said information at a later time. Digital signatures additionally provide evidence of the origin, identity, and status of an electronic document and can confirm the contractual consent of a signatory.

In one embodiment, the disposal object information determined by the acquisition device can deviate from the input value over a range defined as permissible. The input value may preferably comprise the (expected) disposal object type and/or the (expected) disposal object quantity. Such a discrepancy can be treated as a trigger event, whereupon the user/customer (as signing device) can be informed. Through the initiated signature event, the auditor device receives a tamper-proof feedback that the user has received the message about an incorrect indication of the waste quantity and/or type. In particular, it can thereby be advantageously proven—also in retrospect—that the customer or user has received this information and under certain circumstances, has been informed about an increase in costs. Furthermore, it is possible that the customer or user can react directly to the trigger event and give the auditor permission (e.g. as a new input value) to continue the disposal of the waste and/or inform the auditor that the process has been aborted.

Preferably, a trigger event is an unforeseen situation or event, such as a deviation or discrepancy between an input value and an actual recorded value (e.g., via the acquisition device). This discrepancy or trigger event is preferably detected by the auditor device based on the auditing information. The trigger event preferably occurs when a planned pre-agreed execution is not possible and new requirements are made due to the situation. The trigger event can also be determined using artificial intelligence algorithms described further above.

In another embodiment, the trigger event may preferably be defined as a scheduled event. For example, documentation of a process progress at predefined process points may be transmitted to a customer or user. Whereas the user (via a signing device) transmits a signature with an acknowledgement of receipt of information at a process point.

In another preferred embodiment, the signature process can be initiated automatically based on a trigger event or manually based on an external input, for example, an input value for the auditor device.

In the sense of the disclosure, the term “tamper-proof” preferably means that the integrity of transmitted data is maintained and also that the authenticity of the device transmitting the data is ensured. Data transmitted with a digital signature can be considered tamper-proof in the sense of the disclosure. Furthermore, the auditor device can also transmit messages with a digital signature, so that the message transmitted to the signing device is also preferably designed to be tamper-proof.

In the sense of the disclosure, a signing device can preferably be designed as a device or a terminal which is assigned to a responsible person (a user/customer) or a signatory and/or a responsible office (e.g. control center of a waste disposal company or also a fire station). Such a signing device can be, for example, a smartphone, s cell phone, tablet PC, desktop PC, laptop, generally an internet-capable device, with a computer program product installed thereon, which is adapted to create and send as well as receive and decrypt digital signatures. Preferably, the signing device also comprises a security module.

The data transmission between the signing device and the auditor device can preferably take place via a decentralized server and/or via internet communication, wherein the data transmission is cryptographically secured in particular via integrated security modules.

In another preferred embodiment, the system is characterized in that the auditor device is adapted to,
(i) generate a request data set comprising a first electronic document and a signature request
(ii) transmit the request data set to a signing device and wherein a signing device is adapted to,
(iii) generate a response data set comprising the first and/or a second electronic document and an electronic signature
(iv) transmit the response record to the auditor institution

An electronic document preferably has data selected from the group comprising location data, vehicle data, personal data, audio data, image data, text data and/or video data. In this regard, the data included in the electronic document is preferably data related to the trigger event.

The request record is preferably generated automatically by the auditor device after a trigger event has occurred and/or a manual entry has been made as an input value. In addition to the first electronic document and the signature request, the request data set can also include a signature of the auditor device. This advantageously enables the tamper-proof provision of information about the trigger event.

The signature request of the request data record includes a signature specification that can be specified by the auditor device and defines a minimum security level that the electronic signature of the signing device must have over the electronic document. By means of the signature specification, the auditor device can advantageously already make a corresponding specification with regard to the security level of the requested signature that it considers to be at least necessary, which can then be processed automatically without further intervention or further input by the signing device in this regard. This can considerably accelerate and simplify the signature process. This is highly beneficial for user acceptance.

In a further preferred embodiment, at least two signature levels with different security levels of the electronic signature are specified for the electronic signature, and the signature requirement comprises a signature specification which can be specified by the auditor device and which defines a minimum security level which the electronic signature of the signing device must at least have over the electronic document.

For example, two signature levels are preferred: advanced electronic signature and qualified electronic signature. The former is also known as Advanced Electronic Signature or AES for short. The qualified electronic signature (QES) represents the highest security level. On the one hand, it has all the properties that also characterize the AES, plus additional security criteria.

In a preferred embodiment, the response record includes tamper-proof confirmation from the signing device that it has received the information about the trigger event. The confirmation may take the form of providing the transmitted electronic document to the signing device with a signature of the signing device and returning it to the auditor device. In other words, the simple confirmation provides the auditor with information about the signature of the signing device.

In a further preferred embodiment, a second digital document can also be generated by the signing device, which is provided with a signature and transmitted to the auditor device. This second document may include reaction data with instructions for further action, such as a release, for the continuation of the disposal process or the abortion of the process.

In a further preferred embodiment of the disclosure, the system is characterized in that the work station, in particular a press plunger, is adapted to compress the disposal object in the work process, with the press plunger covering a travel distance until a working pressure is reached. The preferred control has a positive effect on the wear of the work station, since a defined working pressure is not exceeded. In addition, this prevents damage to the press due to overload.

In the sense of the disclosure, the work station is preferably a part of a compactor. Preferably, it is a hydraulic waste compactor, whereby the pressure ram is movably mounted within a container. Hydraulic compactors operate according to the hydrostatic principle. The hydrostatic principle is known to the person skilled in the art. The advantage of such a hydraulic press is that high forces can be applied to the press.

According to the disclosure, the press has at least one hydraulically driven press plunger (or press ram, pestle, punch, stamp). Said plunger moves along a travel path in the direction of a counterpart, the counterpart preferably having a wall-like structure. In the sense of the disclosure, the counterpart is preferably a container wall. In an alternative embodiment, the counterpart is also configured as a press plunger.

In the sense of the disclosure, the work station preferably has a carriage and rails. In a preferred embodiment, the plunger is mounted on the rails via the carriage so as to be movable in one degree of freedom. Displacement is possible between the carriage and the rails relative to each other. Thus, in one embodiment, the carriage on which the pressure stamp or press plunger is mounted is preferably moved on the rails. Advantageously, little friction is applied during the movement.

In the sense of the disclosure, the working pressure is preferably the pressure applied in the press by moving the press plunger to compress the disposal object. In an alternative embodiment, a maximum working pressure is specified as a threshold value based on auditing information from the control device. When the threshold value is reached, which is detected by the acquisition device, the press plunger is moved back to its initial position. The threshold value has a beneficial effect on wear and prevents damage due to overloading.

In a further preferred embodiment of the disclosure, the system is characterized in that the acquisition device is adapted to determine the traverse path and/or the working pressure by the press plunger, and the security module is adapted to store the recorded data. Storing the data has the advantage that errors that have occurred in the system can be traced and identified after a work process.

The acquisition device preferably comprises a displacement sensor or distance sensor. A displacement sensor is preferably a component selected from (but not limited to) the group comprising: laser rangefinder, radar sensor, ultrasonic sensor, incremental encoder, wire length encoder, image sensor, etc. Displacement sensors are known to the person skilled in the art.

The acquisition device preferably comprises a pressure sensor. A pressure sensor is preferably a component selected from (without being limited to) the group comprising: piezoresistive pressure sensor, piezoelectric pressure sensor, Hall element pressure sensor, capacitive pressure sensor, inductive pressure sensor, etc. These pressure sensors are known to the skilled person.

In another preferred embodiment of the disclosure, the system is characterized in that the control device is adapted to determine the travel path and/or the working pressure by the press plunger (pressure ram, tappet, stamp) based on the auditing information. Advantageously, this enables an individual work process to be carried out for processing a disposal object.

According to the disclosure, the auditor device transmits a SET value, which is based on the auditing information, to the control device. The control device instructs the press plunger to reach a SET value or SET state from an ACTUAL value or ACTUAL state with regard to a travel path and/or working pressure. The ACTUAL value or ACTUAL state corresponds to a value or state at a point in time before or during the work process. The SET value or SET state corresponds to a value or state at a later point in time compared to the ACTUAL value.

In another preferred embodiment of the disclosure, the system is characterized in that the status information is selected from the group comprising (ambient) temperature, solar radiation, (air) pressure, (air) humidity, and/or air contamination.

It is preferred in the sense of the disclosure that the status information describes those parameters that act externally on the system, its component or the workstation. For example, the status information may relate to a temperature in a room where the workstation is located. It may also relate, for example, to a humidity, an ambient pressure, a time of day, a brightness, etc., without being limited thereto.

In a further preferred embodiment of the disclosure, the system is characterized in that the operating information is selected from the group comprising (system) temperature, operating fluid level, (operating) forces, (operating) pressures and/or system size. The terms operating parameter and operating information are preferably used as synonyms and preferably describe a (system) internal variable.

In another preferred embodiment of the disclosure, the system is characterized in that the disposal object information is selected from the group comprising object image, object size, object temperature, object density, object surface, and/or waste type, for example green waste, bulky waste, plastic waste, waste glass, residual waste, waste paper, and/or electronic waste.

In the sense of the disclosure, an object image is preferably an image of an object or parts thereof, in particular the disposal object and/or the product. An image is preferably a digital photograph. A photograph can advantageously be taken with only one acquisition device (preferably comprising a camera) and has a plurality of information.

In another preferred embodiment of the disclosure, the system is characterized in that the security module is adapted to store a disposal route, a disposal location, a disposal time and/or the type of disposal object and/or product provided. The advantage of such storage is that the data can be accessed retroactively, while being secured by the security module with the highest security standards, so that the data is protected against manipulation or unauthorized removal.

According to the disclosure, the disposal route is a route that preferably exhibits a starting point at the location where the disposal object is provided. The end point of this route is the place where the product is disposed of. Accordingly, the end point is preferably also the disposal location. The time at which the product is disposed of at the disposal location is the disposal time in the sense of the disclosure.

In another preferred embodiment of the disclosure, the system is characterized in that the acquisition device comprises an optical sensor, preferably a camera, and the auditor device and/or acquisition device is adapted to analyze the product information via computer algorithms, preferably using artificial intelligence. Computer-based analysis of acquired product information, such as captured image information of the product, allows more detailed and better results, compared to manual analysis of images. In addition, the analysis can be easily integrated into the flow of the system.

Various sensors can be used as optical sensors or image sensors, which preferably convert light into an electrical signal using the photoelectric effect or exhibit an electrical resistance dependent on the incident radiation. Suitable optical sensors or image sensors can be selected, for example, from a group comprising: photocells, photomultipliers, microchannel plate multipliers, CMOS sensors, CCD sensors, photodiodes, phototransistors, etc. These sensors are known to the skilled person. Particularly preferably, the acquisition device comprises a camera with CCD sensors.

This is particularly economical and provides qualitatively sufficiently informative images with regard to the following evaluation.

In a preferred embodiment, the supervised learning methods described above, in particular an artificial neural network, are also used to analyze the acquisition information. This is also a preferred a classification. In the sense of the disclosure, the input data is preferably defined by the acquisition information. This can be, for example, an image of the product. According to the disclosure, target data is preferably defined by the classification of the acquisition information into a certain class. Likewise, probabilities for the membership in a certain class can furthermore be output as target data. Thus, in view of the example, the target data or output is a classification into a particular type of waste, for example, plastic waste.

However, unsupervised learning and reinforcement learning methods may likewise be used.

In another preferred embodiment of the disclosure, the system is characterized in that the system comprises a GPS tracking unit adapted to determine the disposal route and location and the security module comprises an integrated real-time clock adapted to determine the disposal time. Advantageously, this enables the precise indication of a service rendered for the disposal of a disposal object. In particular, the GPS positioning unit makes it possible to track the disposal route of the disposal object in terms of location and time within a waste disposal facility between the acceptance point, various work stations, in particular the pressing station, sorting facility, etc., and a storage location. It is also possible to trace the disposal route in relation to a transportable waste compactor. This means, for example, that the disposal route can be invoiced on the basis of the actual kilometers traveled. It is also possible to take into account any toll charges incurred on the disposal route.

A GPS positioning unit is known to the person skilled in the art. According to the disclosure, the determined location and time data are stored in one of the system components.

In addition to the proposed system, an analogous method, which is preferably executable by means of the system, is also subject matter of the disclosure.

In another aspect of the disclosure, a method for the controlled processing, monitoring and billing of waste disposal is characterized in that
a) a disposal object, namely waste, is provided;
b) an input value is transmitted from a decentralized server to an auditor device; c) an acquisition device detects at least one disposal object information and/or one operating information and/or one status information;
d) the disposal object information and/or the operating information and/or status information is transmitted to the auditor device;
e) an auditing information is created by the auditor device based on the disposal object information of the operating information and/or the status information and the input value;
f) a control device controls a work station and starts and/or regulates a work process for processing the disposal object depending on the auditing information;
g) a product obtained by the working process is detected via the acquisition device and the resulting product information is transmitted to the auditor device;
h) the auditing information is supplemented with the product information and billing information is generated based thereon;
wherein one or more data transmission processes are cryptographically secured by at least one security module.

Definitions, preferred embodiments, or beneficial effects described with respect to the proposed system apply analogously to the proposed method, and vice versa.

In a further preferred embodiment, the method is characterized in that the auditor device initiates a signature process when a trigger event occurs, wherein the auditor device transmits a message about the trigger event to a signing device and/or a signing device transmits a tamper-proof confirmation to the auditor device that the trigger event has been acknowledged and/or a signing device transmits a tamper-proof release to the auditor device for continuation or abortion of the controlled processing of waste.

Such a method preferably allows direct feedback to the auditor device via a signing device, e.g., in the event of security-relevant incidents, a system stop could be initiated or a legally binding notice could be transmitted. In a further preferred embodiment of the disclosure, the method is characterized in that the billing information is based on the analysis of the auditing information.

In a further preferred embodiment of the disclosure, the method is characterized in that the product is marked, preferably by a coloring and/or fluorescent liquid. The advantage of marking the product makes it possible to process several disposal objects in the same waste compactor and still establish an assignment to a user afterwards.

In a preferred embodiment, the marking is created by a marking station. The marking station preferably comprises means for applying a coloring and/or fluorescent liquid. Particularly preferably, the liquid is applied to the product by spraying. In an alternative embodiment, the liquid is preferably applied by brushing.

In a preferred embodiment of the disclosure, several disposal objects are processed one after the other in one system. After a first product has been created, it is marked and all essential information is acquired (recorded) by the acquisition device. Subsequently, a second disposal object is provided to the system, accordingly a second product is created and all essential information is acquired by the acquisition device. The auditor device is adapted to evaluate the acquired information of the acquisition device via machine learning methods in such a way that the individual products can be assigned to the individual users.

In a further embodiment of the disclosure, the products are characterized by a partition. The partition preferably has a different material compared to the product and is intended to separate the product from a new disposal object located spatially after the product. The acquisition device is adapted to detect the markings and to transmit information on said markings to the auditor device.

In another preferred embodiment, the labeling is heat-based. For example, waste can be fused using a heating station to act as a partition.

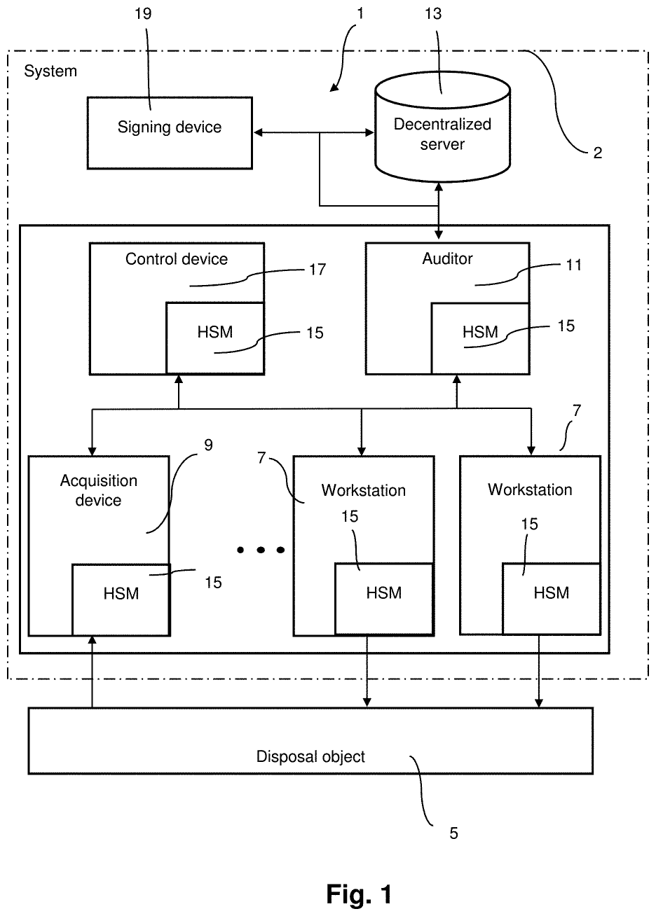

FIG. 1 schematically shows a system 1 in which one or more work stations 7 each perform a work process on a disposal object 5. By way of example, the work station 7 can be a press plunger and/or a marking station in a waste compactor. The disposal object 5 is processed into a product by a work process. Via a decentralized server 13, an input value is transmitted to the auditor device 11 in a first step. The acquisition device 9, on the other hand, determines an operating information, a status information, a disposal object information and/or a product information and sends these to the auditor device 11. Based on said information, the auditor device 11 creates an auditing information and transmits the audit information to the control device 17. Based on the auditing information, the control device 17 controls and/or regulates the work station 7. The work process is continued until a predefined threshold value (e.g. working pressure) is reached, which is detected by the acquisition device 9. The entire work process is preferably monitored by the acquisition device 9. After the product has also been analyzed by the auditor device 11 on the basis of acquired information from the acquisition device 9, individual billing information can be generated. Preferably, these can be sent by the auditor device 11 to a decentralized server 13. Preferably, security modules (HSM) 15 are used in all system components to increase security. Thus, preferably, all data transmission processes are cryptographically secured. It is understood that however not all data transmission processes must necessarily be carried out in a cryptographically secured manner. In preferred embodiments, for example, it is sufficient if at least one data transmission process is cryptographically secured.

In addition, a signing device 19 is preferably included in the system 1. The signing device 19 is preferably in data communication with the decentralized server 13 and/or the auditor device 11. It is particularly preferred that the auditor device 11 is in data communication with the signing device 19, whereby the auditor device 11 can detect a trigger event. After a trigger event, the auditor device 11 preferably sends a request data set with a signature request to the signing device 19. The signing device 19, on the other hand, preferably generates a response data set with an electronic signature in response to the signature request. The response data set is preferably provided to the auditor device 11.

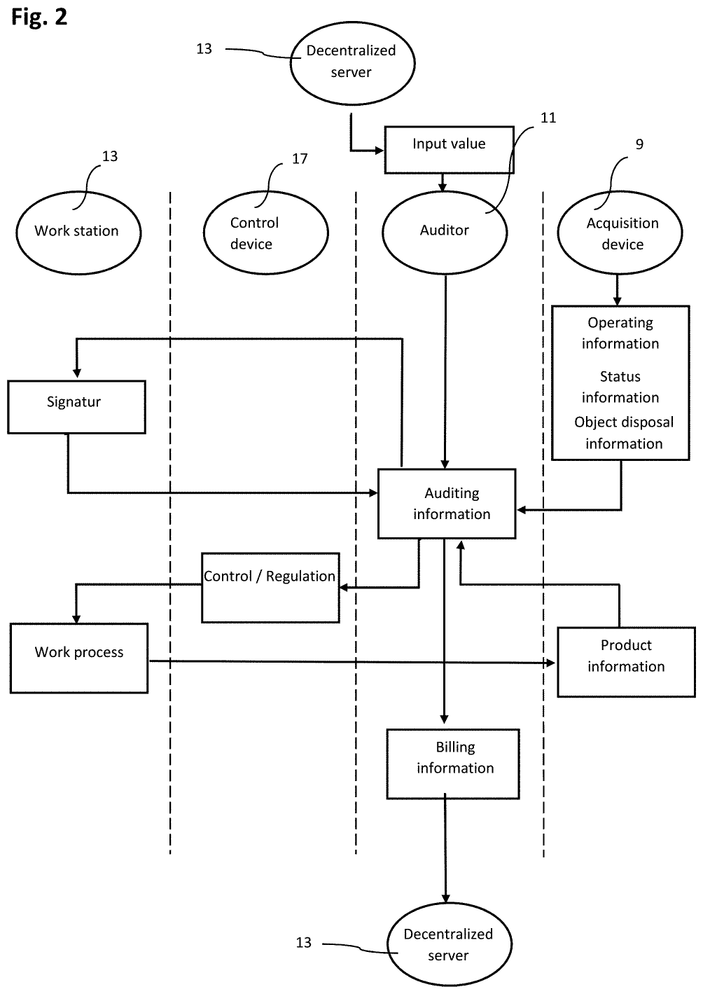

FIG. 2 shows an example of a flow chart performed by system 1. A disposal object 5 is present in system 1. In a first step, an input value is provided by a decentralized server 13. The input value is transmitted to an auditor device 11. Furthermore, an acquisition device 9 acquires an operating information, a status information and/or a disposal object information. The auditor device 11 generates auditing information from the input value and the acquired information of the acquisition device 9. Based on the auditing information, a control device 17 controls and/or regulates a work station 7. The work station converts the disposal object 5 into a product, whereupon a product information is acquired by the acquisition device 9. The product information is then transmitted to the auditor device 11. The auditor device 11 supplements the auditing information with the product information and generates billing information based thereon. Said information in turn can be provided to a decentralized server 13. All data transmission processes are cryptographically secured by at least one security module (HSM) 15.

The auditor device 11 can preferably detect a trigger event based on the auditing information.

The information content of the trigger event is preferably transmitted to a signing device 19. In this context, it is preferably provided that a signing device 19, which may be defined, for example, by a terminal device of a customer, transmits a tamper-proof confirmation of the receipt of information to the auditor device 11. Such a tamper-proof confirmation can preferably be obtained by a digital signature. Based on the confirmation, the auditing information can be revised and thereupon a billing information can be generated and/or an adapted control or regulation of the workstation 7 can be performed.

### LIST OF REFERENCE SIGNS

1 System
2 System boundary
5 Disposal object
7 Workstation
9 Acquisition device
11 Auditor Device
13 Decentralized or remote server
15 Security module (HSM)
17 Control device (controller)
19 Signing device

1. A system for controlled processing, monitoring, and billing of the disposal of a disposal object, comprising: a workstation, a controller, a security module, an acquisition device, an auditor, and a decentralized server, wherein:
the decentralized server is configured to transmit an input value to the auditor;
the acquisition device is configured to detect: disposal object information of a disposal object, operating information, and/or status information;
the auditor is configured to generate auditing information based on: the disposal object information, the operating information, and/or the status information and the input value;
the controller is configured to control the workstation and to initiate and/or regulate a work process for processing the disposal object based on the auditing information;
the acquisition device is configured to acquire product information about a product obtained by the working process and to transmit the product information to the auditor device;
the auditor is configured to supplement the auditing information with the product information, and to generate billing information based on the auditing information supplemented with the product information thereon; and
the security module is configured to cryptographically secure one or more data transmission processes.

2. The system according to claim 1, wherein the auditor is configured to assign identification information to the disposal object and/or the product based on the auditing information.

3. The system according to claim 1, further comprising a signing device, the auditor device being configured to initiate a signature process based on a trigger event, wherein:
the signing device is provided with a message about the trigger event;
the auditor device is provided with a tamper-proof confirmation from the signing device of knowledge of the trigger event; and/or
the auditor device is provided with a tamper-proof release of the signing device for a continuation or an abortion of the controlled processing, monitoring, and billing of the disposal of the disposal object.

4. The system according to claim 1, wherein the workstation is a press plunger that is configured to compress the disposal object in the working process, the press plunger covering a travel path until a working pressure is reached.

5. The system according to claim 4, wherein the acquisition device is configured to determine the travel path and/or the working pressure, the security module being configured to store the acquired data.

6. The system according to claim 4, wherein the controller is configured to determine the travel path and/or the working pressure by the press plunger based on the auditing information.

7. The system according to claim 1, wherein the status information is an ambient temperature, solar radiation, pressure, humidity, and/or air contamination.

8. The system according to claim 1, wherein the operating information is a facility temperature, an operating fluid level, one or more operating forces, one or more operating pressures, and/or a facility size.

9. The system according to claim 1, wherein the disposal object information is an object size, an object temperature, an object density, an object surface, and/or a waste type.

10. The system according to claim 1, wherein the security module is configured to store a disposal route, a disposal location, a disposal time, a type of disposal object, and/or a type of product provided.

11. The system according to claim 1, wherein the acquisition device includes an optical sensor, and the auditor device and/or the acquisition device is configured to analyze the product information using artificial intelligence.

12. The system according to claim 1, further comprising a global positions system (GPS) tracker that is configured to determine a disposal route and location, wherein the security module includes an integrated real-time clock configured to determine a disposal time.

13. A method for controlled processing, monitoring, and billing of the disposal of an object of disposal, the method comprising:
providing a disposal object;
transmitting an input value from a decentralized server to an auditor;
detecting, by an acquisition device, disposal object information, operating information, and/or status information;
transmitting the disposal object information, the operating information, and/or status information to the auditor;
creating auditing information, by the auditor, based on the disposal object information, the operating information, and/or the status information and the input value;
by a controller, controlling a workstation and initiating and/or regulating a work process for processing the disposal object based on the auditing information;
detecting a product obtained by the working process via the acquisition device, and transmitting product information resulting from the detection of the product to the auditor;
supplementing the auditing information with the product information to generate billing information; and
cryptographically securing, by a security module, one or more data transmission processes.

14. The method according to the claim 13,
wherein a signature process is initiated, by the auditor, in response to a trigger event, and
wherein:
a message is transmitted, by the auditor, about the trigger event to a signing device;
a tamper-proof confirmation is transmitted, by the signing device, to the auditor that confirms knowledge of the trigger event; and/or
tamper-proof release is transmitted, by the signing device, to the auditor for continuation or abortion of the controlled processing, monitoring, and billing of the disposal of the disposal object.

15. The method according to claim 13, wherein the billing information is based on:
an analysis of the auditing information, and/or
a characterization of the product by a coloring and/or fluorescent liquid.

16. The system according to claim 9, wherein the waste type is green waste, bulky waste, plastic waste, waste glass, residual waste, waste paper, and/or electronic waste.

17. The system according to claim 1, wherein the disposal object is waste.
